(19) United States
(12) Patent Application Publication
(10) Pub. No.: US 2006/0057684 A1
(43) Pub. Date: Mar. 16, 2006

(54) Mashing process

(75) Inventors: Henrik Bisgaard-Frantzen, Bagsvaerd (DK); Kurt Dorrich, Grenzach-Wyhlen (DE); Wolfgang Hannemann, Oberwiesen (DE); Rikke Festersen, Copenhagen K (DE); Poul Borge Rosenius, Bagsvaerd (DE)

Correspondence Address: NOVOZYMES NORTH AMERICA, INC., 500 FIFTH AVENUE, SUITE 1600, NEW YORK, NY, 10110, US

(73) Assignee: NOVOZYMES A/S, BAGSVAERD (DE)

(21) Appl. No.: 10/520,956

(22) PCT Filed: Jul. 4, 2003
(86) PCT No.: PCT/DK03/00474

§ 371 Date: Jan. 10, 2005

(30) Foreign Application Priority Data
Jul. 25, 2002 (DK) DK PA 2002 01136
Nov. 4, 2002 (DK) DK PA 2002 01691

(51) Int. Cl. C12C 1/00

(52) U.S. Cl. 435/93

(57) ABSTRACT

The present invention provides processes for production of wort and beer from grist mashed at high temperature.

### FIELD OF THE INVENTION

The present invention relates to an improved mashing process for production of a standardized high quality wort and for production of a similarly high quality beer.

### BACKGROUND OF THE INVENTION

Traditionally beer has been brewed from just barley malt, hops and water. In many countries the use of barley malt is still a prerequisite for marketing the product as “beer”. However, often part of the barley malt is substituted with adjuncts such as corn, rice, sorghum, and wheat, refined starch or readily fermentable carbohydrates such as sugar or syrups. Adjuncts are used mainly because they provide carbohydrates at a lower cost than is available from barley malt. As the adjunct contributes insufficient or no enzyme activity for the conversion of starch into fermentable sugars, the barley malt must contain endogenous enzyme activity enough to degrade the barley malt as well as the adjunct into fermentable sugars and free amino acids for yeast nutrition. Thus in the conventional mashing process the quality of the wort produced is very dependent on the enzyme activity of the barley malt used. However, if a mashing process for producing a high quality wort and beer could be provided, wherein the quality is not affected by the endogenous enzyme activity of the barley malt, barley malts of more varying standard could be used in beer production. It is the intention of this disclosure to provide such processes.

### SUMMARY OF THE INVENTION

In a first aspect of the present invention is provided a process for production of a wort, comprising, forming a mash comprising between 5% and 100% barley malt, adding prior to, during or after forming the mash a protease (E.C. 3.4.) and a cellulase (E.C. 3.2.1.4), attaining within 15 minutes of forming the mash an initial incubation temperature of at least 70° C., followed by incubation of the mash at a temperature of at least 70° C. for a period of time sufficient to achieve an extract recovery of at least 80%, and separating the wort from the spent grains.

A second aspect of the present invention provides a process for production of a beer, comprising obtaining the wort of the first aspect, and fermenting said wort with a yeast, and obtaining a beer.

A third aspect of the present invention provides a process for production of a beer, comprising obtaining the wort of the first aspect, blending said wort with a second wort, fermenting the blended wort with a yeast, obtaining a beer.

A forth aspect of the present invention provides a process for production of a beer, comprising obtaining the wort of the first aspect of the invention, fermenting said wort with a yeast, combining said fermented wort with a fermented second wort, and obtaining a beer.

A fifth aspect and a sixth aspect of the present invention provides respectively a wort and a beer produced by the processes of the invention.

### DETAILED DESCRIPTION OF THE INVENTION

Brewing processes are well-known in the art, and generally involve the steps of malting, mashing, and fermentation. In the traditional brewing process the malting serves the purpose of converting insoluble starch to soluble starch, reducing complex proteins, generating color and flavor compounds, generating nutrients for yeast development, and the development of enzymes. The three main steps of the malting process are steeping, germination, and kilning.

Steeping includes mixing the barley kernels with water to raise the moisture level and activate the metabolic processes of the dormant kernel. In the next step, the wet barley is germinated by maintaining it at a suitable temperature and humidity level until adequate modification, i.e. such as degradation of starch and activation of enzymes, has been achieved. The final step is to dry the green malt in the kiln. The temperature regime in the kiln determines the color of the barley malt and the amount of enzymes which survive for use in the mashing process. Low temperature kilning is more appropriate for malts when it is essential to preserve enzymatic activity. Malts kilned at high temperatures have very little or no enzyme activity but are very high in coloring such as caramelized sugars as well as in flavoring compounds.

Mashing is the process of converting starch from the milled barley malt and solid adjuncts into fermentable and unfermentable sugars to produce wort of the desired composition. Traditional mashing involves mixing milled barley malt and adjuncts with water at a set temperature and volume to continue the biochemical changes initiated during the malting process. The mashing process is conducted over a period of time at various temperatures in order to activate the endogenous enzymes responsible for the degradation of proteins and carbohydrates. By far the most important change brought about in mashing is the conversion of starch molecules into fermentable sugars. The principal enzymes responsible for starch conversion in a traditional mashing process are alpha- and beta-amylases. Alpha-amylase very rapidly reduces insoluble and soluble starch by splitting starch molecules into many shorter chains that can be attacked by beta-amylase. The disaccharide produced is maltose.

The traditional method of mashing is the infusion process, in which brewers produce and recover the wort at a single mash temperature. It is most commonly associated with the production of ales and stouts, and is also successfully used by some lager brewers. Traditionally lager beer has often been brewed using a method referred to as “step-infusion”. This mashing procedure involves a series of rests at various temperatures, each favoring one of the necessary endogenous enzyme activities. To day the double-mash infusion system is the most widely used system for industrial production of beer, especially lager type beer. This system prepares two separate mashes. It utilizes a cereal cooker for boiling adjuncts and a mash tun for well-modified, highly enzymatically active malts. As the traditionally mashing processes utilize the endogenous enzymes of the barley malt the temperature is maintained below 70° C. as inactivation of the enzymes would otherwise occur.

After mashing, when all the starch has been broken down, it is necessary to separate the liquid extract (the wort) from the solids (spent grains). Wort separation is important because the solids contain large amounts of protein, poorly modified starch, fatty material, silicates, and polyphenols (tannins). The objectives of wort separation include the following:
to produce clear wort,
to obtain good extract recovery, and
to operate within the acceptable cycle time.

Wort clarity, extraction, recovery, and overall cycle times is greatly affected by the standard of the grist, e.g. the barley malt and the types of adjunct, as well as the applied mashing procedure.

Following the separation of the wort from the spent grains the wort may be fermented with brewers yeast to produce a beer.

Further information on conventional brewing processes may be found in “Technology Brewing and Malting” by Wolfgang Kunze of the Research and Teaching Institute of Brewing, Berlin (VLB), 2nd revised Edition 1999, ISBN 3-921690-39-0.

The present invention provides processes for producing high quality wort and, high quality beer using barley malts of a standard which in a conventional mashing process may not yield a quality product. The high temperature applied to the processes of the present invention ensures that the activity of the various endogenous enzymes of the barley malt or of the adjunct is significantly reduced or even eliminated. Thus at temperatures in the interval 70° C. to 78° C. only the barley malt alpha- and beta-amylases will exhibit notable activity, and at temperatures above 78° C. the endogenous enzymes activity will be negligible. In the mashing process of the present invention added enzymes will thus constitute a very essential part of or all enzyme activity. While endogenous enzymes of the barley malt, including unwanted activities, such as lipoxygenase, are eliminating by the high process temperatures of the present invention, the positive characteristics of the barley malt, e.g. the coloring and flavor components as well as the protein contribution, are retained. The application of a standardized mixture of thermostable enzymes ensures a high extract recovery, full control of the protease activity allowing optimal foam stability, and a very low total beta-glucan content facilitating wort separation and thereby reducing cycle time even with a high percentage of unmalted barley or undermodified barley. The present invention also provides processes that allow production of a wort and/or a beer with reduced amounts of trans-2-noneal (T2N) and/or dimethyl sulfide (DMS), the compounds responsible for the two most important off-flavors encountered in beer.

Without being bound by theory it is believed that the reduction of T2N is due to the inactivation of the malt lipoxygenase and peroxygenase by temperatures above 70° C. In a conventional process such temperatures are not applicable as the endogenous enzymes needed during mashing would likewise be inactivated.

As it will be evident from this disclosure the present invention provides a unique possibility to control the mashing process in respect to uniform wort quality and thereby to uniform beer quality.

Definitions

Throughout this disclosure, various terms that are generally understood by those of ordinary skill in the arts are used. Several terms are used with specific meaning, however, and are meant as defined by the following.

As used herein the term “grist” is understood as the starch or sugar containing material that's the basis for beer production, e.g. the barley malt and the adjunct.

The term “malt” is understood as any malted cereal grain, in particular barley.

The term “adjunct” is understood as the part of the grist which is not barley malt. The adjunct may be any starch rich plant material.

The term “mash” is understood as a starch containing slurry comprising crushed barley malt, other starch containing material, or a combination hereof, steeped in water to make wort.

The term “wort” is understood as the unfermented liquor run-off following extracting the grist during mashing.

The term “spent grains” is understood as the drained solids remaining when the grist has been extracted and the wort separated.

The term “beer” is here understood as a fermented wort, i.e. an alcoholic beverage brewed from barley malt, optionally adjunct and hops.

The term “gelatinization temperature” is understood as the temperature at which gelatinization of the starch commences. Starch begins to gelatinize between 60° C. and 70° C., the exact temperature dependent on the specific starch.

The term “extract recovery” in the wort is defined as the sum of soluble substances extracted from the grist (malt and adjuncts) expressed in percentage based on dry matter.

The term “incubation” is understood as the part of the process beginning from the attainment of the initial incubation temperature till the temperature drops below the final incubation temperature. The incubation may comprise one or more steps at different temperatures, all of which are at least 70° C.

The term “initial incubation temperature” is understood as the temperature regime during the initial part of the incubation in question.

The term “final incubation temperature” is understood as the temperature. regime during the final part of the incubation in question.

The term “a thermostable enzyme” is understood as an enzyme that under the temperature regime and the incubation period applied in the processes of the present invention in the amounts added is capable of sufficient degradation of the substrate in question.

The term “a maltose generating enzyme” is understood as an essentially exo-acting enzyme catalyzing the splitting of the alpha-1-4 links of linear starch and limit dextrins yielding maltose. Examples of maltose generating enzymes are beta-amylase (E.C. 3.2.1.2) and maltogenic alpha-amylase (E.C. 3.2.1.133).

Trans-2-nonenal (T2N) gives the stale off-flavor referred to as cardboard flavor. T2N is an oxidation product resulting from autooxidation and/or enzyme catalyzed oxidation of lipids. The T2N level is influenced by both raw materials and the mashing process applied. Focus has been put on barley varieties with low levels of precursors and of lipoxygenase. Furthermore, it has been shown that low pH in the final product favors formation of T2N while increasing amount of SO₂ lowers the formation of T2N.

Dimethyl sulfide (DMS) is the most important sulfur flavor compound and a troublesome flavor in beer. It can vary in intensity from cooked corn to cooked vegetables, notably corn, celery, cabbage or parsnips, even garlic. In extreme cases, it may even be reminiscent of shellfish or water in which shrimp has been boiled. DMS is normally produced by the conversion of S-methyl-methionine. DMS (P) represents the levels of DMS precursors, such as S-methyl methionine (SMM) and dimethyl sulfoxide (DMSO), in the malt.

The term “homology” when used about polypeptide or DNA sequences and referred to in this disclosure is understood as the degree of homology between two sequences indicating a derivation of the first sequence from the second. The homology may suitably be determined by means of computer programs known in the art such as GAP provided in the GCG program package (Program Manual for the Wisconsin Package, Version 8, August 1994, Genetics Computer Group, 575 Science Drive, Madison, Wis., USA 53711) (Needleman, S. B. and Wunsch, C. D., (1970), Journal of Molecular Biology, 48, 443-453. The following settings for polypeptide sequence comparison are used: GAP creation penalty of 3.0 and GAP extension penalty of 0.1.

In accordance with the first aspect of the invention a starch containing slurry, the mash, is obtained by mixing a grist comprising at least 5%, or preferably at least 10%, or more preferably at least 15%, even more preferably at least 25%, or most preferably at least 35%, such as at least 50%, at least 75%, at least 90% or even 100% (w/w of the grist) barley malt with water. Preferably at least 5%, preferably at least 10%, more preferably at least 20%, even more preferably at least 50%, at least 75% or even 100% of the barley malt is well modified barley malt. In one embodiment the grist comprises other malted grain than barley malt, so that at least 10%, at least 25%, preferably at least 35%, more preferably at least 50%, even more preferably at least 75%, most preferably at least 90% (w/w) of the grist is other malted grain than barley malt.

Prior to forming the mash the malted and/or unmalted grain is preferably milled and most preferably dry milled. In a preferred embodiment the husks are removed from the malted and/or unmalted grain before forming the mash. Removal of husks may be applied where the mashing programs comprising temperatures above 75° C., such as at temperatures above 76° C., 77° C., 78° C., 79° C., 80° C., 81° C., 82° C., 83° C., 84° C., 85° C. or even above 86° C.

According to the invention enzyme activities needed for the mashing process to proceed are exogenously supplied and may be added to the mash ingredients, e.g. the water or the grist before forming the mash, or it may be added during or after forming the mash. The enzymes are preferably supplied all at one time at the start of the process; however, one or more of the enzymes may be supplied at one or more times prior to, at the start, or during the process of the invention. The following enzyme activities are added to the mash; a protease (E.C. 3.4.) and a cellulase (E.C. 3.2.1.4). In a particularly preferred embodiment also an alphaamylase (E.C. 3.2.1.1) and/or a maltose generating enzyme is added. The maltose generating enzyme is preferably a beta-amylase (E.C. 3.2.1.2) or even more preferably a maltogenic alpha-amylase (E.C. 3.2.1.133).

In yet a preferred embodiment a further enzyme is added, said enzyme being selected from the group consisting of laccase, lipase, glucoamylase, phospholipolase, phytase, phytin esterase, pullulanase, and xylanase.

The water may preferably, before being added to the grist, be preheated in order for the mash to attain the initial incubation temperature at the moment of mash forming. If the temperature of the formed mash is below the initial incubation temperature additional heat is preferably supplied in order to attain the initial process temperature. Preferably the initial incubation temperature is attained within 15 minutes, or more preferably within 10 minutes, such as within 9, 8, 7, 6, 5, 4, 2 minutes or even more preferably within 1 minute after the mash forming, or most preferably the initial incubation temperature is attained at the mash forming.

The initial incubation temperature is preferably at least 70° C., preferably at least 71° C., more preferably at least 72° C., even more preferably at least 73° C., or most preferably at least 74° C., such as at least 75° C., at least 76° C., at least 77° C., at least 78° C., at least 79° C., at least 80° C., at least 81° C., such as at least 82° C. The mashing process of the invention includes incubating the mash at the initial incubation temperature of at least 70° C. and maintaining a temperature of at least 70° C., preferably at least 71° C., more preferably at least 72° C., even more preferably at least 73° C., or most preferably at least 74° C., such as at least 75° C., at least 76° C., at least 77° C., at least 78° C., at least 79° C., at least 80° C., at least 81° C., at least 82° C., at least 83° C., at least 84° C., or at least 85° C. i.e. a temperature that never falls below 70° C. for the duration of the incubation period. During the incubation period the temperature is preferably held below 100° C., such as below 99° C., 98° C, 97° C., 96° C., 95° C., 94° C., 93° C., 92° C., 91° C., or even below 90° C.

The temperature may be held constant for the duration of the incubation, or, following a period of an essentially constant temperature (the initial incubation temperature) for the first part of the incubation the temperature may be raised, either as a slow continuously increase, or as one or more stepwise increment(s) during the incubation. Alternatively the temperature may be decreased during the incubation. In one embodiment the initial incubation temperature. is at least 70° C. and during the incubation the temperature is increased with at least 1° C., 2° C., 3° C., 4° C., 5° C., 6° C., 7° C., 8° C., 9° C. or preferably with at least 10° C., or more preferably With at least 12° C., such as 15° C. In another embodiment the initial incubation temperature is at least 75° C., or preferably at least 80° C., and the temperature is decreased during the incubation with at least 5° C., or preferably with at least 1° C., 2° C., 3° C., 4° C., 5° C., 6° C., 7° C., 8° C., 9° C. or preferably with at least 10° C., or more preferably with at least 15° C. In a particular embodiment the incubation comprises maintaining the mash at a temperature of at least 75° C., preferably at least 76C., more, preferably at least 77° C., even more preferably at least 78° C., such as at least 79° C. at least 80° C., at least 81° C., 82° C., 83° C., 84° C., 85° C., 86° C., 87° C., 88° C., 89° C. or at least 90° C. for a period of at least 1 minute, preferably for at least 5 minutes, more preferably for at least 15 minutes, even more preferably for at least 20 minutes, such as at least 30 minutes, at least 40 minutes, at least 50 minutes, at least 60 minutes, at least 90 minutes, or at least 120 minutes. In another particular embodiment the incubation comprises maintaining the mash at a temperature of at least 75° C., preferably at least 76° C., more preferably at least 77° C., even more preferably at least 78° C., such as at least 79° C., at least 80° C., such as at least 81° C., 82° C., 83° C., 84° C., 85° C., 86° C., 87° C., 88° C., 89° C. or at least 90° C. for at least 1% of the total incubation time, preferably for at least 5%, more preferably for at least 15%, even more preferably for at least 20%, or at least 30%, at least 40%, at least 50%, at least 60%, at least 70%, at least 80%, at least 90%, such as for 100% of the total incubation time.

The duration of the incubation is preferably at least 15 minutes, typically between 30 minutes and 2½ hours, e.g. at least 45 minutes, at least 1 hour, at least 1¼ hour, at least 1½ hour, at least 1% hour or at least 2 hours.

In addition to barley malt the grist may preferably comprise adjunct such as unmalted barley, or other malted or unmalted grain, such as wheat, rye, oat, corn, rice, milo, millet and/or sorghum, or raw and/or refined starch and/or sugar containing material derived from plants like wheat, rye, oat, corn, rice, milo, millet, sorghum, potato, sweet potato, cassava, tapioca, sago, banana, sugar beet and/or sugar cane. For the invention adjuncts may be obtained from tubers, roots, stems, leaves, legumes, cereals and/or whole grain. Preferably the adjunct to be added to the mash of the invention has gelatinization temperatures at or below the process temperature. If adjuncts such as rice or corn, or other adjuncts with similar high gelatinization temperature, are to be used in the process of the invention, they may preferably be cooked separately to ensure gelatinization before being added to the mash of the invention, or the gelatinized adjunct starch may be mashed separately from the mash of the invention by adding appropriate enzymes to ensure saccharification before being added to the mash of the invention. Methods for gelatinization and saccharification of brewing adjuncts are well known in the arts. Adjunct comprising readily fermentable carbohydrates such as sugars or syrups may be added to the barley malt mash before, during or after mashing process of the invention but is preferably added after the mashing process. Preferably a part of the adjunct is treated with a protease and/or a beta-glucanase before being added to the mash of the invention. During the mashing process, starch extracted from the grist is gradually hydrolyzed into fermentable sugars and smaller dextrins. Preferably the mash is starch negative to iodine testing, before extracting the wort.

Obtaining the wort from the mash typically includes straining the wort from the spent grains, i.e. the insoluble grain and husk material forming part of grist. Hot water may be run through the spent grains to rinse out, or sparge, any remaining extract from the grist. The application of a thermostable cellulase in the process of the present invention results in efficient reduction of beta-glucan level facilitating wort straining thus ensuring reduced cycle time and high extract recovery. Preferably the extract recovery is at least 80%, preferably at least 81%, more preferably at least 82%, even more preferably at least 83%, or most preferably at least 84%, such as at least 85%, or at least 86%.

In the embodiment wherein the husks are removed from malted and/or unmalted grain comprised in the grist the wort separation may comprise a centrifugation step.

According to a second aspect of the invention the wort produced by the process of the first aspect of the invention may be fermented to produce a beer. Fermentation of the wort may include pitching the wort with a yeast, slurry comprising fresh yeast, i.e. yeast not previously used for the invention or the yeast may be recycled yeast. The yeast applied may be any yeast suitable for beer brewing, especially yeasts selected from Saccharomyces spp. such as S. cerevisiae and S. uvarum, including natural or artificially produced variants of these organisms., The methods for fermentation of wort for production. of beer are well known to the person skilled in the arts.

According to a third aspect of the invention, the wort produced by the process of the first aspect of the invention may, in order to produce a beer, prior to fermentation be blended with a second wort.

According to a fourth aspect of the invention, the beer produced by the process of the second or third aspects of the invention may, in order to produce a beer, be blended with a fermented second wort.

The second wort of the third and fourth aspect may also be a product of the process of the invention or it may be a product of a conventional process. In a preferred embodiment the second wort is the product of a mashing process conducted at a temperature of at least 70° C. Preferably the second wort is prepared from a grist comprising at least 10%, at least 25%, at least 50%, at least 75%, or at least 90% unmalted barley. Preferably the second wort is produced from a mash to which no proteolytic enzyme has been added. Preferably the second wort is produced from a mash to which a beta-glucanase and/or an alpha-amylase have been added.

The processes of the second, third and fourth aspect may include adding silica hydrogel to the fermented wort to increase the colloidal stability of the beer. The processes may further include adding kieselguhr to the fermented wort and filtering to render the beer bright.

The beer produced by the processes of the second, third and fourth aspect of the invention may be any type of beer. Preferred beer types comprise ales, strong ales, stouts, porters, lagers, bitters, export beers, malt liquors, happoushu, high-alcohol beer, low-alcohol beer, low-calorie beer or light beer.

The standardized enzyme composition as well as the high temperatures applied during the processes of the present invention have a reducing effect on the concentration of important off-flavor coursing compounds. Preferably the concentration of DMS of the wort and/or the beer is reduced, compared to the level in a wort or beer produced by the standard Congress mashing procedure, such as by at least 10%, at least 20%, at least 30%, at least 40%, at least 50%, or at least 60% relative to the level in respectively a wort or beer produced by standard Congress mashing procedure. Preferably the concentration of T2N of the wort or the beer is reduced, compared to the level in respectively a wort or a beer produced by the standard Congress mashing procedure, such as reduced by at least 10%, at least 20%, at least 30%, at least 40%, at least 50%, or at least 60%.

Enzymes

The enzymes to be applied in the present invention should be selected for their ability to retain sufficient activity at elevated temperatures, such as at the process temperature of the processes of the invention, as well as for their ability to retain sufficient activity under the moderately acid pH regime in the mash and should be added in effective amounts. The enzymes may be derived from any source, preferably from a plant or an algae, and more preferably from a microorganism, such as from a bacteria or a fungi.

Protease

Suitable proteases include microbial proteases, such as fungal and bacterial proteases. Preferred proteases are acidic proteases, i.e., proteases characterized by the ability to hydrolyze proteins under acidic conditions below pH 7.

Contemplated acid fungal proteases include fungal proteases derived from Aspergillus, Mucor, Rhizopus, Candida, Coriolus, Endothia, Enthomophtra, Irpex, Penicillium, Sclerotiumand Torulopsis. Especially contemplated are proteases derived from Aspergillus niger (see, e.g., Koaze et al., (1964), Agr. Biol. Chem. Japan, 28, 216), Aspergillus saitoi (see, e.g., Yoshida, (1954) J. Agr. Chem. Soc. Japan, 28, 66), Aspergillus awamori (Hayashida et al., (1977) Agric. Biol. Chem., 42(5), 927-933, Aspergillus aculeatus (WO 95/02044), or Aspergillus oryzae, such as the pepA protease; and acidic proteases from Mucor pusillus or Mucor miehei.

Contemplated are also neutral or alkaline proteases, such as a protease derived from a strain of Bacillus. A particular protease contemplated for the invention is derived from Bacillus amyloliquefaciens and has the sequence obtainable at Swissprot as Accession No. P06832. Also contemplated are the proteases having at least 90% homology to amino acid sequence obtainable at Swissprot as Accession No. P06832 such as at least 92%, at least 95%, at least 96%, at least 97%, at least 98%, or particularly at least 99%.,

Further contemplated are the proteases having at least 90% homology to amino acid sequence disclosed as SEQ.ID.NO:1 in the Danish patent applications PA 2001 01821 and PA 2002 00005, such as at 92%, at least 95%, at least 96%, at least 97%, at least 98%, or particularly at least 99%.

Also contemplated are papain-like proteases such as proteases within E.C. 3.4.22.* (cysteine protease), such as EC 3.4.22.2 (papain), EC 3.4.22.6 (chymopapain), EC 3.4.22.7 (asclepain), EC 3.4.22.14 (actinidain), EC 3.4.22.15 (cathepsin L), EC 3.4.22.25 (glycyl endopeptidase) and EC 3.4.22.30 (caricain).

The proteases are responsible for reducing the overall length of high-molecular-weight proteins to low-molecular-weight proteins in the mash. The low-molecular-weight proteins are a necessity for yeast nutrition and the high-molecular-weight-proteins ensure foam stability. Thus it is well-known to the skilled person that protease should be added in a balanced amount which at the same time allows amble free amino acids for the yeast and leaves enough high-molecular-weight-proteins to stabilize the foam. Proteases may be added in the amounts of 0.1-1000 AU/kg dm, preferably 1-100 AU/kg dm.and most preferably 5-25 AU/kg dm.

Cellulase (E.C. 3.2.1.4)

The cellulase may be of microbial origin, such as derivable from a strain of a filamentous fungus (e.g., Aspergillus, Trichoderma, Humicola, Fusarium). Specific examples of cellulases include the endo-glucanase (endo-glucanase 1) obtainable from H. insolens and further defined by the amino acid sequence of FIG. 14 in WO 91/17244 and the, 43 kD H. insolens endo-glucanase described in WO 91/17243.

A particular cellulase to be used in the processes, of the invention may be an endo-glucanase, such as an endo-1,4-beta-glucanase. Contemplated are beta-glucanases having at least 90% homology to amino acid sequence disclosed as SEQ.ID.NO:1 in Danish patent application PA2002 00130, such as at least 92%, at least 95%, at least 96%, at least 97%, at least 98%, or particularly at least 99%.

Commercially available cellulase preparations which may be used include CELLUCLAST®, CELLUZYME®, CEREFLO® and ULTRAFLO® (available from Novozymes A/S), LAMINEX™ and SPEZYME® CP (available from Genencor Int.) and ROHAMENT® 7069 W (available from Röhm, Germany).

Beta-glucanases may be added in the amounts of 1.0-10000 BGU/kg dm, preferably from 10-5000 BGU/kg dm, preferably from 50-1000 BGU/kg dm and most preferably from 100-500 BGU/kg dm.

Alpha-Amylase (EC 3.2.1.1)

A particular alpha-amylase to be used in the processes of the invention may be any fungal alpha-amylase. Especially contemplated are fungal alpha-amylases which exhibit a high homology, i.e. at least 50%, at least 55%, at least 60%, at least 65%, at least 70%, at least 75%, at least 80%, at least 85% or even at least 90% homology to the amino acid sequence shown in SEQ ID No. 10 in WO96/23874. Fungal alpha-amylases may be added in an amount of 1-1000 AFAU/kg DM, preferably from 2-500 AFAU/kg DM, preferably 20-100. AFAU/kg DM.

Another particular alpha-amylase enzyme to be used in the processes of the invention may be a Bacillus alpha-amylase. Well-known Bacillus alpha-amylases include alpha-amylase derived from a strain of B. licheniformis, B. amyloliquefaciens, and B. stearothermophilus. Other Bacillus alpha-amylases include alpha-amylase derived from a strain of the Bacillus sp. NCIB 12289, NCIB 12512, NCIB 12513 or DSM 9375, all of which are described in detail in WO95/26397, and the alpha-amylase described by Tsukamoto et al., Biochemical and Bio-physical Research Communications, 151 (1988), pp. 25-31. In the context of the present invention a contemplated , Bacillus alpha-amylase is an alpha-amylase as defined in WO99/19467 on page 3, line 18 to page 6, line 27. A preferred alpha-amylase has an amino acid sequence having at least 90% homology to SEQ ID NO:4 in WO99/19467, such as at least 92%, at least 95%, at least 96%, at least 97%, at least 98%, or particularly at least 99%. Most preferred variants of the maltogenic alpha-amylase comprise the variants disclosed in WO99/43794. Contemplated variants and hybrids are described in WO96/23874, WO97/41213, and WO99/19467. Specifically contemplated is a recombinant B. stearothermophilus alpha-amylase variant with the mutations; I181*+G182*+N193F. Bacillus alpha-amylases may be added in the amounts of 1.0-1000 NU/kg dm, preferably from 2.0-500 NU/kg dm, preferably 10-200 NU/kg dm.

Maltogenic Alpha-Amylase

A particular enzyme to be used in the processes of the invention is a maltogenic alpha-amylase (E.C. 3.2.1.133). Maltogenic alpha-amylases (glucan 1,4-alpha-maltohydrolase) are able to hydrolyse amylose and amylopectin to maltose in the alpha-configuration. Furthermore, a maltogenic alpha-amylase is able to hydrolyse maltotriose as well as cyclodextrin. Specifically contemplated maltogenic alpha-amylases may be derived from Bacillus sp., preferably from Bacilus stearothermophilus, most preferably from Bacillus stearothermophilus C599 such as the one described in EP 120.693. This particular maltogenic alpha-amylase has the amino acid sequence shown as amino acids 1-686 of SEQ ID NO:1 in U.S. Pat. No. 6,162,628. A preferred maltogenic alpha-amylase has an amino acid sequence having at least 90% homology to amino acids 1-686 of SEQ ID NO:1 in U.S. Pat. No. 6,162,628 preferably at least 92%, at least 95%, at least 96%, at least 97%, at least 98%, or particularly at least 99%. Most preferred variants of the maltogenic alpha-amylase comprise the variants disclosed in WO99/43794.

Maltogenic alpha-amylases may be added in amounts of 0. 1-1000 MANU/kg dm, preferably from 1-100 MANU/kg dm, preferably 5-25 MANU/kg dm.

Beta-Amylase

Another particular enzyme to be used in the processes of the -invention may be a beta-amylase (E.C 3.2.1.2).,

Beta-amylases have been isolated from various plants and microoganisms (W. M. Fogarty and C. T. Kelly, Progress in Industrial Microbiology, vol. 15, pp. 112-115, 1979). These beta-amylases are characterized by having optimum temperatures in the range from 40° C. to 65° C. and optimum pH in, the range from 4.5-to 7.0. Specifically contemplated beta-amylase include the beta-amylases SPEZYME® BBA 1500, SPEZYME® DBA and OPTIMALT™ ME, OPTIMALT™ BBA from Genencor Int. as well as the beta-amylases NOVOZYM™ WBA from Novozymes A/S. Beta-amylases may be added in effective amounts well known to the person skilled in the art.

Additional Enzymes

A further particular enzyme to be used in the processes of the invention may be a glucoamylase (E.C.3.2.1.3) derived from a microorganism or a plant. Preferred are glucoamylases of fungal or bacterial. origin selected from the group consisting of Aspergillus glucoamylases, in particular A. niger G1 or G2 glucoamylase (Boel et al. (1984), EMBO J. 3 (5), p.1097-1102), or variants thereof, such as disclosed in WO92/00381 and WO00/04136; the A. awamori glucoamylase (WO84/02921), A. oryzae (Agric. Biol. Chem. (1991), 55 (4), p. 941-949), or variants or fragments thereof.

Other contemplated Aspergillus glucoamylase variants include variants to enhance the thermal stability: G137A and G139A (Chen et al. (1996), Prot Engng. 9, 499-505); D257E and D293E/Q (Chen et al. (1995), Prot. Engng. 8, 575-582); N182 (Chen et al. (1994), Biochem. J. 301, 275-281); disulphide bonds, A246C (Fierobe et al. (1996), Biochemistry, 35, 8698-8704; and introduction of Pro residues in position A435 and S436 (Li et al. (1997), Protein Engng. 10, 1199-1204). Other contemplated glucoamylases include Talaromyces glucoamylases, in particular derived from Talaromyces emersonii (WO99128448), Talaromyces leycettanus (U.S. Pat. No. Re. 32,153), Talaromyces duponti, Talaromyces thermophilus (U.S. Pat. No. 4,587,215). Bacterial glucoamylases contemplated include glucoamylases from the genus Clostridium, in particular C. thermoamylolyticum (EP 135,138), and C. thermohydrosulfuricum (WO86/01831). Preferred glucoamylases include the glucoamylases derived from Aspergillus oryzae, such as a glucoamylase having at least 90%, at least 92%, at least 95%, at least 96%, at least 97%, at least 98%, or particularly at least 99%. even at least 90% homology. to the amino acid sequence shown in SEQ ID NO:2 in WO00/04136. Also contemplated are the commercial products AMG 200L; AMG 300 L; SAN™ SUPER and AMG™ E (from Novozymes); OPTIDEX™ 300 (from Genencor Int.); AMIGASE™ and AMIGASE™ PLUS (from DSM); G-ZYME™ G900 (from Enzyme Bio-Systems); G-ZYME™ G990 ZR (A. niger glucoamylase and low protease content). Glucoamylases may be added in effective amounts well known to the person skilled in the art.

Another enzyme of the process may be a debranching enzyme, such as an isoamylase (E.C. 3.2.1.68) or a pullulanases (E.C. 3.2.1.41). Isoamylase hydrolyses alpha-1,6-D-glucosidic branch linkages in amylopectin and beta-limit dextrins and can be distinguished from pullulanases by the inability of isoamylase to attack pullulan, and by the limited action on alpha-limit dextrins. Debranching enzyme may be added in effective amounts well known to the person skilled in the art.

Materials and Methods

Enzymes

A protease (EC 3.4.24.28) from Bacillus amyloliquefaciens and having the sequence disclosed as Swissprot Accession No P06832.

A protease having the amino acid sequence shown as amino acids no. 1-177 of SEQ.ID.NO 2 in Danish patent applications PA 2001 01821 and PA 2002 00005.

A cellulase (E.C. 3.2.1.4), a beta-glucanase having the amino acid sequence shown as SEQ.ID.NO1 in Danish. patent application PA-2002 00130.

An alpha-amylase (E.C. 3.2.1.1) from B. stearothermophilus having the amino acid sequence disclosed as SEQ. NO:4 in WO99/19467 with the mutations: I181*+G182*+N193F.

A maltogenic alpha-amylase (E.C. 3.2.1.133) having the amino acid sequence 1-686 of SEQ ID NO:1 in patent application WO1016340.

Barley Malt

The barley malt used had the following characteristics.

Analysis of the barley malt used in example 1-5 (Analytica-EBC
methods).

| | | Modified malt | Well modified malt |
|---|---|---|---|
| Moisture | % | 4.1 | 4.4 |
| Extract dry | % | 81.9 | 82.74 |
| Saccharification | min | 10 | 10 |
| Soluble N | % | 0.69 | 0.61 |
| Kolbach Index | % | 40 | 37 |
| Diastatic activity | WK | 321 | 324 |
| beta-glucan | mg/l | 135 | 82 |
| Modification | % | 98 | 98 |

Methods
Proteolytic Activity (AU)

The proteolytic activity may be determined with denatured hemoglobin as substrate. In the Anson-Hemoglobin method for the determination of proteolytic activity-denatured hemoglobin is digested, and the undigested hemoglobin is precipitated with trichloroacetic acid (TCA). The amount of TCA soluble product is determined with phenol reagent, which gives, a blue color with tyrosine and tryptophan.

One Anson Unit (AU) is defined as the amount of enzyme which under standard conditions (i.e. 25° C., pH 7.5 and 10 min. reaction time) digests hemoglobin at an initial rate such that there is liberated per minute an amount of TCA soluble product which gives the same color with phenol reagent as one milliequivalent of tyrosine.

A folder AF 4/5 describing the analytical method in more detail is available upon request to Novo Nordisk ANS, Denmark, which folder is, hereby included by reference.

Alpha-Amylase Activity (NU)

The amylolytic activity may be determined using potato starch as substrate. This method is based on the break-down of modified potato starch by the enzyme, and the reaction is followed by mixing samples of the starch/enzyme solution with an iodine solution. Initially, a blackish-blue color is formed, but during the break-down of the starch the blue color gets weaker and gradually turns into a reddish-brown, which is compared to a colored glass standard.

One Kilo Novo alpha amylase Unit (KNU) equals 1000 NU. One KNU is defined as the amount of enzyme which, under standard conditions (i.e. at 37° C.+/−0.05; 0.0003 M Ca2+; and pH 5.6) dextrinizes 5.26 g starch dry substance Merck Amylum solubile.

A folder AF 9/6 describing this analytical method in more detail is available upon request to Novozymes A/S, Denmark, which folder is hereby included by reference.

Maltogenic Alpha-Amylase Activity (MANU)

One Maltogenic Amylase Novo Unit (MANU) is defined as the amount of enzyme which under standard will cleave one micro mol maltotriose per minute. The standard conditions are 10 mg/ml maltotriose, 37° C., pH 5.0, and 30 minutes reaction time. The formed glucose is converted by glucose dehydrogenase (GlucDH, Merck) to gluconolactone under formation of NADH, which is determined by photometric at 340 nm. A detailed description of the analytical method (EAL-SM-0203.01) is available on request from Novozymes.

Glucoamylase Activity (AGU)

The Novo Glucoamylase Unit (AGU) is defined as the amount of enzyme, which hydrolyzes 1 micromole maltose per minute at 37° C. and pH 4.3.

The activity is determined as AGU/ml by a method modified after (AEL-SM-0131, available on request from Novozymes), using the Glucose GOD-Perid kit from Boehringer Mannheim, 124036. Standard: AMG-standard, batch 7-1195, 195 AGU/ml. 375 microL substrate (1% maltose in 50 mm Sodium acetate, pH 4.3) is incubated 5 minutes at 37° C. 25 microL enzyme diluted in sodium acetate is added. The reaction is stopped after 10 minutes by adding 100 microL 0.25 M NaOH. 20 microL is transferred to a 96 well microtitre plate and 200 microL GOD-Perid solution (124036, Boehringer Mannheim) is added. After 30 minutes at room temperature, the absorbance is measured at 650 nm and the activity calculated in AGU/ml from the AMG-standard. A detailed description of the analytical method (AEL-SM-0131) is available on request from Novozymes.

Beta-Amylase Activity (DPO)

The, activity of SPEZYME® BBA 1500 is expressed in Degree of Diastatic Power (DP°). It is the amount of enzyme contained in 0.1 ml of a 5% solution of the sample enzyme preparation that will produce sufficient reducing sugars to reduce 5 ml of Fehling's solution when the sample is incubated with 100 ml of substrate for 1 hour at 20° C.

Beta-Glucanase Activity (BGU)

The cellulytic activity may be measured in beta-glucanase units (BGU). Beta-glucanase reacts with beta-glucan to form glucose or reducing carbohydrate which is determined as reducing sugar using the Somogyi-Nelson method. 1 beta-glucanase unit (BGU) is the amount of enzyme which, under standard conditions, releases glucose or reducing carbohydrate with a reduction capacity equivalent to 1 μmol glucose per minute. Standard conditions are 0.5% beta-glucan as substrate at pH 7.5 and 30° C. for a reaction time of 30 minutes. A detailed description of the analytical method (EB-SM-0070.02/01) is available on request from Novozymes A/S.

Standard Congress Mashing Process

The standard Congress mashing process was performed according to the procedure of EBC: 4.5.1 Extract of Malt: Congress Mash. The temperature profile consisted of initial incubation temperature of 45° C. for 30 minutes, increasing to 70° C. with 1.0° C/min for 25 minutes, finalized by 70° C. for 65 minutes giving a total incubation period of 2 hours.

Additional Methods

Methods for analysis of raw products, wort, beer etc. can be found in Analytica-EBC, Analysis Committee of EBC, the European Brewing Convention (1998), Verlag Hans Carl Geranke-Fachverlag. For the present invention the methods applied for determination of the following parameters were:
Plato: refractometer.
Assimilable N: Based on EBC: 8.10 but with TNBS (2,4,6 trinitrobenzen sulphonic acid) as reagent instead of ninhydrin. TNBS reacts in a solution of free amino groups or amino acids and peptides, which creates a yellow complex, which is measured spectrophotometric at 340 nm.
Beta-glucan: EBC: 8.13.2 (High Molecular weight beta-glucan content of wort: Fluorimetric Method).
Color: EBC: 4.7.2
Modification EBC: 4.14 Modification and Homogenity of malt, Calcoflour method
Filterability: Volume of filtrate (ml) determination: According to EBC: 4.5.1 (Extract of Malt: Congress Mash) subsection 8.2. Filtration: Filtration volume is read after 1 hour of filtration through fluted filter paper, 320 mm diameter. Schleicher and Schüll No.597 ½, Machery, Nagel and Co. in funnels, 200 mm diameter, fitted in 500 ml flasks.
pH: EBC: 8.17 (pH of Wort).
Kolbach Index: EBC: 4.9.1 (Soluble Nitrogen of Malt: Spectrophotometric Method) and EBC: 3.3.1 (Total Nitrogen of Barley: Kjeldahl Method (RM)).
T2N: Gas chromatography with mass spectrometric detection (GC-MS).
DMS (P) and. DMS: Methods based on Hysert, D. W et al. (1979): Dimethyl sulphide precursor in beer, J. ASBC 37/4, 169-174 and Mundy, A. P. (1991): The determination of Dimethyl Sulphide in Beer by Headspace Gas Chromatography—a Collaborative investigation of Precession. J. Inst. Brew., 97, 45-46.
Extract recovery: EBC: 4.5.1 (Extract of Malt: Congress Mash, Extract in dry). The term extract recovery in the wort is defined as the sum of soluble substances (glucose, sucrose, maltose, maltotriose, dextrins, protein, gums, inorganic, other substances) extracted from the grist (malt and adjuncts) expressed in percentage based on dry matter. The remaining insoluble part is defined as spent grains.

$$\begin{matrix}{E}_{1} = \frac{P ( M + 800 )}{100 - P} & a ) \\ {E}_{2} = \frac{{E}_{1} \cdot 100}{100 - M} & b )\end{matrix}$$

where;
E₁=the extract content of sample, in % (m/m)
E₂=the extract content of dry grist, in % (m/m)
P=the extract content in wort, in % Plato
M=the moisture content of the grist, in % (m/m)
800=the amount of destined water added into the mash to 100 g of grist
   Identification and Quantification of DMS and trans-2-noneal

Dynamic headspace was used as an isolation procedure, where Nitrogen was added through a closed system of a glass flask containing the wort, and a purge head on which a trap was placed. The collection was carried out as follows: 200 g wort in a 500 ml flask added 1 ml of 4-methyl-1-pentanol (used as Internal standard (IS)). The flask was placed in water bath at 30° C. under magnetic stirring at app. 210 rounds/min. A flow-meter (J & W ADM100, J&W scientific) was used to control the nitrogen flow though the flasks.

DMS was collected and identified by mild N₂-flow of 50 ml/min in 15 minutes, and t-2-n by 300 ml/min in 60 minutes due to the large difference in their volatility properties. DMS is very volatile, thus requires low short collection time at low speed of flow compared to t-2-n. The retention times for DMS and t-2-n were 2.2-2.3 min and 23.5-23.8 min respectively. Overview of flow times and method are listed below.

| Aroma | | | | |
|---|---|---|---|---|
| component | Wort (g) | Flow (ml/min) | Time (min) | MS Method |
| DMS | 200 | 50 | 15 | Scan mode |
| t-2-n | 200 | 300 | 60 | Scan mode |

Separation and identification was carried out using a Hewlett-Packard, G1800A GCD system (GC-MS) with a J&W Scientific DB-WAX column (30 m×0.25 mm and 0.25 μm wide) with helium as carrier gas. The column flow was 1 ml/min, constant pressure at kPa and 53° C. and spilt injection ratio of 1:10. Injector temperature was held at 250° C. and the temperature profile applied was: 45° C. for 10 min, increase to 250° C. with 6° C./min and the temperature was held here for 10 min. Desorption of, the aroma components from Tenax-GR traps were utilized by a Perkin Elmer ATD 400, Automated Thermal Desorper connected to the GC equipment. Identification was based on comparison with the obtained Mass spectra collected from the GC-MS with mass spectra found in the G 1035 A Wiley PBM library (Hewlett-Packard) database. The detector had a mass range of 20-425 mhz.

Quantification was carried out according to prepared standard curves for DMS and t-2-n. The DMS standard curve contained concentrations between 0-150 ppb, and the t-2-n standard curve contained concentrations between 0-5 ppb.

Mash Preparation

Unless otherwise stated mashing was performed as follows. The mash was prepared according to EBC: 4.5.1 using malt grounded according to EBC: 1.1. Mashing trials were performed in 500 ml lidded vessels each containing a mash with 50 g grist and adjusted to a total weight of 450±0.2 g with water preheated to the initial incubation temperature +1° C. During mashing the vessels were incubated in water bath with stirring.

### EXAMPLES

### Example 1

The enzymes, 100 NU Bacillus alpha-amylase, 10 MANU maltogenic alpha-amylase per kg dry matter of mash, and protease and beta-glucanase according to table 1, were added and the vessels were incubated at constant 80° C. for 2 hours. The results in table 1 are means of two duplicates.

TABLE 1
Mashing performed at constant 80° C. for 2 hours. Effect of protease and beta-glucanase level.

| | 212 BGU/kg dm | 424 mg/kg dm | 530 BGU/kg dm | 636 mg/kg dm |
|---|---|---|---|---|
| | beta-glucanase l | beta-glucanase l | beta-glucanase l | beta-glucanase l |
| | 12.5 AU/kg dm | 25 AU/kg dm | 40 AU/kg dm | 50 AU/kg dm |
| | protease | protease | protease | protease |
| Plato % | 8.58 | 8.37 | 9.15 | 9.25 |
| Extract recovery % | 79.53 | 77.4 | 85.34 | 86.37 |
| pH | 5.94 | 5.91 | 5.84 | N.a. |
| Kolbach index | 31 | 31 | 34 | 35 |
| Assimilable N, % | 0.14 | 0.14 | 0.14 | 0.14 |
| Beta-glucan, mg/l | 32.1 | 23.0 | 21.6 | 20.9 |

N.a.: Not analyzed

### Example 2

The enzyme composition was 12.5 AU protease, 212 BGU beta-glucanase, 100 NU Bacillus alpha-amylase, 10 MANU maltogenic alpha-amylase per kg dry matter of mash. The temperature profile consisted of an initial incubation temperature of 70° C. for 60 minutes, followed by an increase of 1.33° C./min for 15 minutes, finalized by 90° C. for 45 minutes giving a total incubation period of 2 hours. The results in table 2 are means of four duplicates.

TABLE 2
Infusion mashing at 70-90° C., incubation period 2 hours.

| | |
|---|---|
| Plato % | 9.3 |
| Extract recovery % | 86.7 |
| pH | 5.8 |
| Colour | 4.2 |
| Kolbach index | 47.8 |
| Assimilable N, % | 0.2 |
| Beta-glucan, mg/l | <20 |

### Example 3

Two high temperature mashing processes of the invention with incubation periods of respectively 2 and 1½ hour and the enzyme combination 212 BGU beta-glucanase, 100 NU Bacillus alpha-amylase, 10 MANU maltogenic alpha-amylase, 12.5 AU protease per kg dm was compared with a standard Congress mashing with no added enzymes.

The produced wort was analyzed for extract recovery, available nitrogen, color and beta-glucan content (Table 3) as well as for various aroma compounds (Table 4). Presented data are means of two duplicates.

The temperature profiles were:
High Temp. 2 hours Initial incubation temperature of 70° C. for 60 minutes, increasing to 90° C., with 1.33° C/min for 15 minutes, finalized by 90° C. for 45 minutes giving a total incubation period of 2 hours.

High Temp. 1½ hour Initial incubation temperature of 70° C. for 40 minutes, increasing to 90° C., with 1.33° C./min for 15 minutes, finalized by 90° C. for 35 minutes giving a total incubation period of 1½ hour.

TABLE 3
The high temperature mashing processes of the invention
performed at 70-90° C., A and B, respectively for
2 and 1½ hours with the enzyme combination
described in the text above compared with C,
a standard Congress mashing.

| | High Temp. | High Temp. | Std. Congress |
|---|---|---|---|
| | 2 hours | 1½ hour | 2 hours |
| Extract recovery (%) | 84.2 | 83.7 | 82.6 |
| Kolbach Index (%) | 44.5 | 45.5 | 40 |
| Assimilable N (%) | 0.19 | 0.17 | 0.18 |
| Colour | 3.5 | 4.05 | 2.9 |
| Beta-glucan, (mg/l) | <20 | <20 | 152 |

TABLE 4
Results of aroma analysis of the wort produced by two processes
of the invention performed at 70-90° C. with the enzyme
combination described in the text above compared with a
standard Congress mashing.

| Aroma components | High Temp. | High Temp. | Std. Congress |
|---|---|---|---|
| ppb | 2 hours | 1½ hour | 2 hours |
| DMS (P) | 155 | 185 | 380 |
| Trans-2-nonenal | 0.20 | 0.25 | 0.50 |
| 2-metyl-butanal | 3.5 | 9.6 | 20 |
| Hexanal | 4 | 10 | 28 |
| 3-metyl-Butanol | 2.1 | 3.2 | 31 |
| 1-Hexanol | 1.05 | 1.55 | 11 |

### Example 4

The wort and the fermented wort produced through the high temperature mashing process of the present invention using an incubation period of 1¾ hour and the enzyme combination 212 BGU beta-glucanase, 100 NU Bacillus alpha-amylase, 10 MANU maltogenic alpha-amylase, 12.5 A U protease per kg dm was compared with the similar products from a standard Congress mashing with no added enzymes.

The temperature profile, consisted of an initial, incubation temperature of 70° C. for 40 minutes, increasing to 90° C., with 1.33° C./min for 15 minutes, finalized by 90° C. for 35 minutes giving a total incubation period of 1¾ hour. Presented data are means of two duplicates.

TABLE 5
Analysis of wort. A high temperature mashing processes of the
invention with the temperature profile and the enzyme combination
described in the text above compared a standard Congress mashing.

| | High Temp. | Std. Congress |
|---|---|---|
| pH | 5.8 | 5.9 |
| Plato % | 8.70 | 8.59 |
| Extract recovery % | 80.8 | 83.0 |
| Total nitrogen % | 0.78 | 0.71 |
| Assimilable N % | 0.16 | 0.16 |
| Starch reaction (Windisch) | Negative | Negative |
| Colour | 4.4 | 3.5 |
| Calcium mg/l | 18 | 20 |
| Zinc mg/l | 1.17 | 0.22 |
| Beta-glucan mg/l | <20 | 130 |
| Trans-2-nonenal ppb | 0.5 | 2.0 |

The wort-from high temperature and congress mashing was transferred, to 2 liter tubes pitched with 2.5 g of yeast per liter and fermented at 14° C. for 7 days., During fermentation, samples were taken for determination of Plato, pH and yeast growth on day 0, 1, 2, 3, 4 and 7.

Following fermentation, samples were taken analyses of trans-2-nonenal and DMS.

TABLE 6
Analysis of fermenting wort. Yeast pitching at day 0.

| | | Plato % | pH | Yeast g/l |
|---|---|---|---|---|
| Day 0 | Std. Congress | 8.6 | 5.45 | 2.95 |
| | High temp. | 8.8 | 5.25 | 3.10 |
| Day 1 | Std. Congress | 6.95 | 4.60 | 7.20 |
| | High temp. | 6.85 | 4.60 | 6.75 |
| Day 3 | Std. Congress | 1.45 | 4.10 | 16.10 |
| | High temp. | 1.60 | 4.00 | 15.20 |
| Day 4 | Std. Congress | 1.30 | 4.10 | 11.70 |
| | High temp. | 1.60 | 4.00 | 10.50 |
| Day 7 | Std. Congress | 1.40 | 4.15 | 3.90 |
| | High temp. | 1.65 | 4.10 | 2.70 |

TABLE 7
Analysis of the fermented wort.

| Aroma components (ppb) | Std. Congress | High Temp. |
|---|---|---|
| Trans-2-nonenal | 0.025 | 0.015 |
| DMS | 39.0 | 22.5 |

### Example 5

Several high temperature mashing processes of the invention were performed in 2 liter volumes using grists consisting of unmalted barley, undermodified barley malt (beta-glucan 200 mg/l) modified barley malt (betaglucan 135 mg/l), well modified barley malt (beta-glucan 82 mg/l) or different proportions of barley malt and unmalted barley (grist:water ratio as above 1:8). Presented data in table 8 are means of three duplicates whereas data in tables 9 to 12 are means of two duplicates.

TABLE 8
Results from mashing using a temperature profile consisting of
70° C. for 40 minutes, increasing for 15 minutes to 90° C.,
finalized by 90° C. for 65 minutes (total 2 hrs). Enzymes are
400 BGU/kg dm beta-glucanase, 12.5 AU/kg dm protease,
100 NU/g dm Bacillus alpha-amylase.

| | 100% | 10% modified barley malt/ | |
|---|---|---|---|
| | unmalted barley | 90% unmalted barley | |
| | With enzymes | With enzymes | No enzymes |
| Plato % | 8.25 | 8.33 | 7.62 |
| pH | 6.23 | 6.23 | 6.39 |
| Extract recovery % | 84.0 | 84.3 | 76.5 |
| Filterability (ml) | 345 | 340 | 90 |
| Beta-glucan (mg/l) | 294 | 224 | 2160 |

TABLE 9
Results from mashing using a temperature profile consisting of
75° C. for 15 minutes, increasing for 15 minutes to 90° C., finalized by
90° C. for 30 minutes (total 1 hrs). Enzymes are 400 BGU/kg
dm beta-glucanase, 12.5 AU/kg dm protease, 100 NU/g dm
Bacillus alpha-amylase

| | 100% | | | | |
|---|---|---|---|---|---|
| | well modified | | 10% | | 100% |
| | malt | | well modified malt/ | | undermodified |
| | With | No | 90% barley | | malt |
| | en- | en- | With | No | With |
| | zymes | zymes | enzymes | enzymes | enzymes |
| Plato % | 9.1 | 8.9 | 8.1 | 7.4 | 9.0 |
| pH | 6.26 | 6.31 | 6.42 | 6.45 | 6.25 |
| Extract | 84.8 | 82.5 | 81.2 | 73.6 | 83.3 |
| recovery % | | | | | |
| Filterability | 325 | 305 | 320 | 55 | 305 |
| (ml) | | | | | |
| Beta-glucan | 30 | 170 | 771 | 1870 | 31 |
| (mg/l) | | | | | |

TABLE 10
Results from mashing using a temperature profile consisting of constant
75° C. for 1 hr. Enzymes are 400 BGU/kg dm beta-glucanase,
12.5 AU/kg dm protease, 100 NU/g dm Bacillus alpha-amylase

| | | | 10% | | 100% |
|---|---|---|---|---|---|
| | 100% | | well modified malt/ | | undermodified |
| | well modified malt | | 90% barley | | malt |
| | With | No | With | No | With |
| | enzymes | enzymes | enzymes | enzymes | enzymes |
| Plato % | 9.2 | 9.1 | 8.3 | 7.6 | 9.1 |
| pH | 6.21 | 6.23 | 6.38 | 6.42 | 6.19 |
| Extract recovery % | 86.1 | 84.8 | 83.9 | 76.6 | 84.8 |
| Filterability (ml) | 335 | 325 | 315 | 125 | 320 |
| Beta-glucan (mg/l) | 13 | 141 | 145 | 1804 | 19 |

TABLE 11
Results from mashing using a temperature profile consisting of
constant 82° C. for 1 hr. Enzymes are 333 BGU/kg dm beta-glucanase,
12.5 AU/kg dm protease, 100 NU/g dm Bacillus
alpha-amylase, 10 MANU/g dm maltogenic alpha-amylase

| | 10% well | | | 100% |
|---|---|---|---|---|
| | modified malt/ | 100% | | undermodified |
| | 90% barley | well modified malt | | malt |
| | With | With | No | With |
| | enzymes | enzymes | enzymes | enzymes |
| Plato % | 8.0 | 9.1 | 8.9 | 9.0 |
| pH | 6.24 | 4.53 | 6.06 | 6.02 |
| Extract | 80.4 | 84.8 | 82.8 | 83.5 |
| recovery % | | | | |
| Filterability | 225 | 330 | 260 | 275 |
| (ml) | | | | |
| Beta-glucan | 710 | 37 | 112 | 54 |
| (mg/l) | | | | |

### Example 6

A highly under-modified malt was mashed in a standard Congress mash with no added enzymes (Table 12), in a Congress mashing with added enzymes (Table 13) and in high temperature mashing with added enzymes (Table 14).

TABLE 12
Characterization of highly under-modified malt, n = 4, carried out as
Congress mashing (no addition of enzymes).

| Quality parameter | Reference (no enzymes) |
|---|---|
| Beta-glucan, mg/l | 1858 |
| Average OD, nm = 700 | 0.044 |
| Average Plato° | 8.65 |
| Extract E2, extract in dry malt, % (m/m) | 82.17 |
| Average viscosity (mPa * s, cP) | 1.83 |

TABLE 13
Overview of results of Congress Mashing of highly under-modified
malt with addition of enzymes.

| | | Beta- | Alpha- | Alpha- |
|---|---|---|---|---|
| | | glucanase | amylase | amylase |
| | | alpha- | xylanase | xylanase |
| | Reference | amylase | (1x std. | (2x std. |
| | (no enzymes) | protease⁵ | dosage)⁶ | dosage)⁷ |
| Beta-glucan¹ | 1850 | 14 | 1721 | 1832 |
| Average OD² | 0.045 | 0.080 | 0.042 | 0.041 |
| Extract³ | 82.46 | 88.16 | 83.83 | 83.59 |
| Average viscosity⁴ | 1.86 | 1.56 | 1.73 | 1.71 |

¹Beta-glucan, mg/l n = 4;
²Average OD at 700 nm n = 2;
³Extract E2, n = 4 in dry malt, % (m/m);
⁴Average viscosity n = 8 (mPa * s);
⁵20 mg EP¹/kg dm, 100 KNU/kg dm, 10 AU/kg dm;
⁶100 KNU/kg dm, 300 FXU/kg dm;
⁷100 KNU/kg dm, 600 FXU/kg dm.

TABLE 14
Overview of results from high temperature mashing of highly
under-modified malt at 70-90° C., 1hour.

| | | Beta- | | |
|---|---|---|---|---|
| | | glucanase | | 5x std. |
| | | alpha- | Alpha- | dosage of |
| | | amylase | amylase | regular |
| | Reference | protease | protease | filtration |
| | (no enzymes) | xylanase | xylanase | enzyme |
| Beta-glucan¹ | 2898 | 175 | 1034 | 1884 |
| Average OD² | 0.146 | 0.137 | 0.119 | 0.165 |
| Extract³ | 81.02 | 84.96 | 85.64 | 82.88 |
| Average viscosity⁴ | 6.99 | 1.39 | 1.52 | 1.74 |

¹Beta-glucan, mg/l n = 4;
²Average OD at 700 nm n = 2;
³Extract E2, n = 4 in dry malt, % (m/m);
⁴Average viscosity n = 8 (mPa * s);
⁵22.5 mg EP/kg dm, 100 KNU/kg dm, 12.5 AU/kg dm 300 FXU/kg dm;
⁶100 KNU/kg dm, 12.5 AU/kg dm, 300 FXU/kg dm;
⁷5x std. dosage of Ultraflo ® L (1000 ppm).

1-27. (canceled)

28. A process for production of a wort, comprising;
a) forming a mash comprising between 5% and 100% barley malt (w/w of the grist);
b) prior to, during or after a) adding a cellulase;
c) attaining within 15 minutes of a) an initial incubation temperature of at least 70° C.;
d) following c) incubating the mash at a temperature of at least 70° C. for a period of time sufficient to achieve an extract recovery of at least 80%; and,
e) separating the wort from the spent grains.

29. The process according to claim 28, further comprising adding a protease is added.

30. The process according to claim 28, further comprising adding an alpha-amylase.

31. The process according to claim 28, further comprising adding a maltose generating enzyme.

32. A process for production of a beer, fermenting the wort from claim 28 with a yeast, and obtaining a beer.

33. A process for production of a beer, combining the wort from claim 28 with a second wort, fermenting the combined wort with a yeast, and obtaining a beer.

34. A process for production of a beer, fermenting the wort from claim 28 with a yeast, combining the fermented wort with a fermented second wort, and obtaining a beer.

35. The process of claim 28, wherein the beer is ales, strong ales, bitters, stouts, porters, lagers, export beers, malt liquors, barley wine, happoushu, high-alcohol beer, low-alcohol beer, low-calorie beer or light beer.

36. The process of claim 28, wherein the concentration of dimethyl sulfide in the wort or the beer is reduced relative to the level in a wort or a beer produced by the standard Congress mashing process.

37. The process of claim 28, wherein the concentration of trans-2-nonenal of the wort or the beer is reduced, relative to the level in a wort or a beer produced by the standard Congress mashing process.

38. The process according to claim 31; wherein the maltose generating enzyme is a beta-amylase or a maltogenic alpha-amylase.

39. The wort produced by the process of claim 28.

40. The beer produced by the process of claim 32.


SEQUENCE LISTING (1 sequence)

SEQ ID NO: 1 - protein, 335 aa, Thermoascus aurantiacus
MKLGSLVLALSAARLTLSAPLADRKQETKRAKVFQWFGSNESGAEFGSQNLPGVEGKDYIWPDPNTIDTLISKGMNIFRVPFMMERLVPNSMTGSPDPNYLADLIATVNAITQKGAYAVVDPHNYGRYYNSIISSPSDFQTFWKTVASQFASNPLVIFDTNNEYHDMDQTLVLNLNQAAIDGIRSAGATSQYIFVEGNSWTGAWTWTNVNDNMKSLTDPSDKIIYEMHQYLDSDGSGTSATCVSSTIGQERITSATQWLRANGKKGIIGEFAGGANDVCETAITGMLDYMAQNTDVWTGAIWWAAGPWWGDYIFSMEPDNGIAYQQILPILTPYL